(19) United States
(12) Patent Application Publication
(10) Pub. No.: US 2025/0300826 A1
(43) Pub. Date: Sep. 25, 2025

(54) SYSTEMS AND METHODS FOR LIVE ENCRYPTION KEY ROTATION

(71) Applicant: Secturion Systems, Inc., CENTERVILLE, UT (US)

(72) Inventor: DEREK OWENS, CENTERVILLE, UT (US)

(73) Assignee: Secturion Systems, Inc., CENTERVILLE, UT (US)

(21) Appl. No.: 18/950,617

(22) Filed: Nov. 18, 2024

Related U.S. Application Data
(60) Provisional application No. 63/606,172, filed on Dec. 5, 2023.

(51) Int. Cl. H04L 9/08; H04L 9/14

(52) U.S. Cl. CPC H04L 9/0891; H04L 9/14

(57) ABSTRACT

Systems and methods related to live encryption key rotation. In one approach, an encryption system determines that use of an old key for encrypting data on a storage system is to be replaced with use of a new key. In response to the determination, the encryption system reads a block of data from the storage system that is encrypted with the old key, decrypts the block of data using the old key, encrypts the block of data using the new key, and writes the block of data encrypted with the new key to the storage system. The encryption system also updates a progress indicator that indicates which locations on the storage system store data encrypted with the old key and which locations on the storage system store data encrypted with the new key.

### RELATED APPLICATIONS

This application claims the benefit, and priority benefit, of U.S. Provisional Patent Application Ser. No. 63/606,172, filed Dec. 5, 2023, entitled “SYSTEMS AND METHODS FOR LIVE ENCRYPTION KEY ROTATION,” by Derek Owens, the disclosure and content of which is incorporated by reference herein in its entirety.

### FIELD OF THE TECHNOLOGY

At least some embodiments disclosed herein relate to encryption in general, and more particularly, but not limited to encryption of stored data.

### BACKGROUND

Encrypting stored data serves a critical purpose of safeguarding sensitive information. Encryption may protect data from unauthorized access, ensuring that only authorized individuals or systems with the appropriate decryption keys can decipher and access the data. This is important to secure such sensitive data as customer information, financial records, personal data, and proprietary business data.

Using the same encryption key for an extended period can pose significant security risks. Over time, an encryption key might become compromised due to factors such as accidental leaks, insider threats, or inadequate key management practices. As such, what is desired are systems and methods for live encryption key rotation.

### BRIEF DESCRIPTION OF THE DRAWINGS

The embodiments are illustrated by way of example and not limitation in the figures of the accompanying drawings in which like references indicate similar elements.

FIG. 1 shows a system for live encryption key rotation in accordance with some embodiments.

FIG. 2 is an illustration of the system of FIG. 1 in a state of partial key rotation.

FIG. 3 is an illustration of the system of FIGS. 1 and 2 in a state of completed key rotation.

FIG. 4 is an illustration of an encryption system processing a read request in accordance with some embodiments.

FIG. 5 is an illustration of an encryption system processing a write request in accordance with some embodiments.

FIG. 6 is an illustration of an encryption system performing live key rotation operations in accordance with some embodiments.

FIG. 7 is a flow diagram of a computer-implemented method for live encryption key rotation in accordance with some embodiments.

### DETAILED DESCRIPTION

At least some embodiments in the following disclosure describe rotating encryption keys used for data storage. At least some embodiments relate to rotating encryption keys in a live environment. For example, systems and methods described herein may use and/or include an encryption device that intercepts input/output (I/O) requests to a storage system to encrypt data written to the storage system and decrypt data read from the storage system. In some examples, the encryption device may facilitate the rotation of encryption keys (e.g., to replace the use of an old encryption key with the use of a new encryption key) by keeping track of which parts of the storage system are storing data using the old key and which parts of the storage system are storing data using the new key. In addition, in some examples, the encryption device may reencrypt data encrypted with the old encryption key using the new encryption key in a manner such that the reencryption poses little or no disruption to live use of the storage system. In this manner, the systems and methods described herein may facilitate the rotation of encryption keys for storage, thereby improving the security of data storage, while minimizing negative performance impacts on the storage system that may otherwise result from reencrypting, e.g., the entire storage system at once.

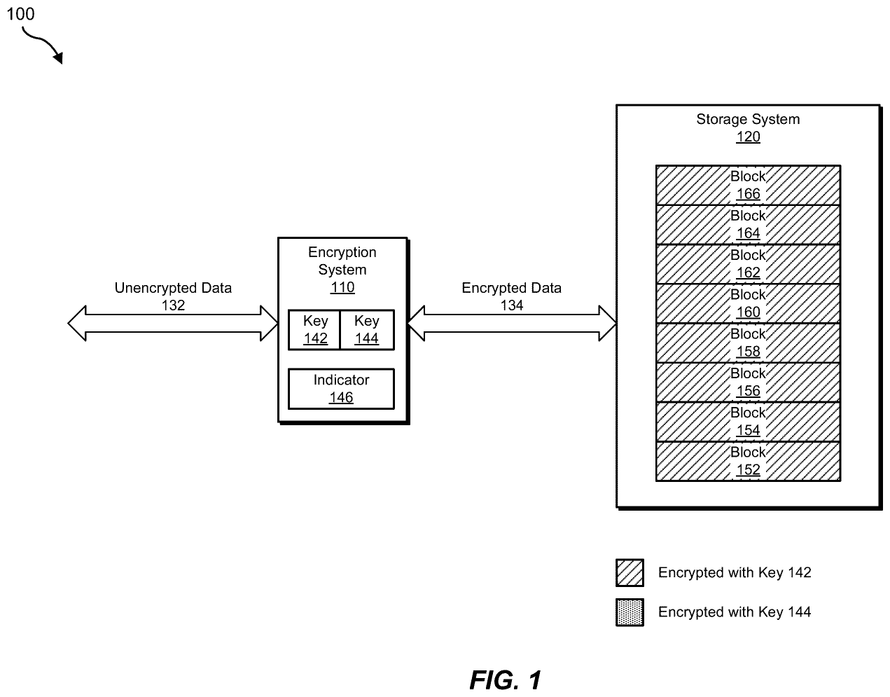

FIG. 1 shows a system 100 for live encryption key rotation. As shown in FIG. 1, system 100 may include an encryption system 110 and a storage system 120. In some examples, encryption system 110 may secure data stored on storage system 120 by encrypting data being written to storage system 120 and decrypting data being read from storage system 120. For example, as shown in FIG. 1, encryption system 110 may receive a write request with unencrypted data 132 destined for storage system 120 and may encrypt unencrypted data 132, resulting in encrypted data 134. In another example, encryption system 110 may receive a read request for data stored on storage system 120, retrieve encrypted data 134, decrypt encrypted data 134, and provide unencrypted data 132 in response to the read request.

In some examples, encryption system 110 may be configured to intercept I/O operations destined for storage system 120. For example, instead of connecting directly to a network (or, e.g., to a client system), storage system 120 may connect indirectly to the network via encryption system 110. Thus, requests to write to or read from storage system 120 may be relayed by and/or may first be processed by encryption system 110.

In some examples, encryption system 110 and storage system 120 may be separate systems that are communicatively coupled. In some examples, encryption system 110 may be directly coupled to, integrated with, and/or a part of storage system 120.

As shown in FIG. 1, encryption system 110 may store one or more encryption keys, such as, e.g., keys 142 and 144. In one example, one or more data blocks (e.g., blocks 152, 154, 156, 158, 160, 162, 164, and 166) may have been previously encrypted (e.g., by encryption system 110) with key 142 and stored on storage system 120. However, in one example, one or more of the systems described herein (e.g., encryption system 110, storage system 120, a cloud storage management system, a data security policy system, etc.) may determine that the use of key 142 is to be replaced (e.g., with the use of key 144). These systems may determine that the use of key 142 is to be replaced in any suitable manner. For example, these systems may receive an instruction to replace the use of key 142 with the use of key 144. Additionally or alternatively, these systems may determine that key 142 has expired and/or is due to expire (e.g., in accordance with a data security policy). In some examples, these systems may determine that key 142 has potentially be compromised.

As will be explained in greater detail below, once encryption system 110 has determined and/or has received an instruction to replace use of key 142, encryption system 110 may initiate an encryption key rotation (i.e., may replace the use of an old encryption key with a new encryption key). In addition, in some examples encryption system 110 may initiate a live encryption key rotation. As used herein, the term “live” as it refers to an encryption key rotation generally refers to any process and/or scenario in which an encryption key rotation is performed on data and/or on a storage system that is accessible and/or actively in use within a computing environment. For example, one or more systems, clients, and/or applications may actively read from and/or write to storage system 120 over a period of time. During this time, storage system 120 and the data stored on storage system 120 may be considered to be “live” (e.g., accessible and in active use). As used herein, the term “production” as it refers to I/O operations may refer to any primary I/O operations (i.e., I/O operations aside those that encryption system 110 performs for reencryption purposes only). For example, the term “production” as it refers to I/O operations may refer to any I/O operations initiated by a client system, a server, an application, or any device external to encryption system 110 and storage system 120. By performing a live encryption key rotation, encryption system 110 may perform operations on storage system 120 and/or the data stored on storage system 120 to replace use of key 142 with key 144 without taking storage system 120 offline, making the data stored on storage system 120 inaccessible, and/or otherwise interfering with the use of storage system 120 and the encrypted data stored thereon.

In addition, and as will be explained in greater detail below, encryption system 110 may include an indicator 146 that tracks which blocks of storage system 120 are encrypted with key 142 and which blocks are encrypted with key 144. Indicator 146 may be implemented in any of a variety of ways, including, e.g., an index that separates blocks encrypted with key 142 and blocks encrypted with key 144 and/or a map of the blocks of storage system 120 that records, for each block, whether the block is encrypted with key 142 or key 144.

In some examples, encryption system 110 may be a dedicated data encryption device. In some examples, encryption system 110 may perform one or more additional operations, including, e.g., one or more authentication processes (e.g., to determine access to write data to and/or read and decrypt data from storage system 120). Encryption system 110 may be in communication with any of a number of client devices, servers, and/or applications. In some examples, system 100 may be a part of a cloud-based storage system.

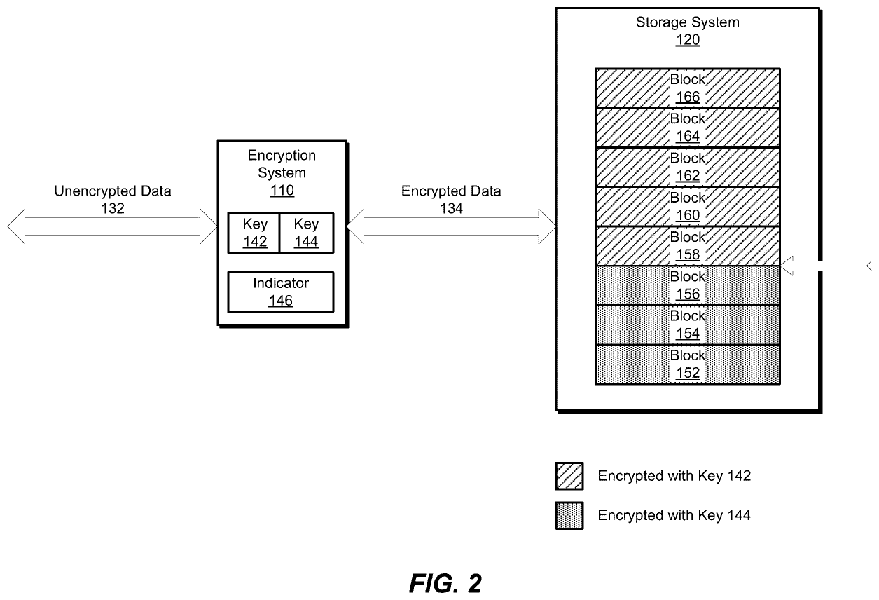

FIG. 2 is an illustration of system 100 of FIG. 1 in a state of partial key rotation. As shown in FIG. 2, blocks 152, 154, and 156 have been reencrypted with key 144 (e.g., decrypted by encryption system 110 using key 142 and then encrypted by encryption system 110 using key 144).

In one example, encryption system 110 may reencrypt blocks on storage system 120 sequentially. For example, encryption system 110 may have started by reencrypting block 152, then reencrypting block 154, and then reencrypting block 156. In these examples, encryption system 110 may maintain indicator 146 as an index that indicates up to what point in the sequence of blocks encryption system 110 has already performed reencryption (e.g., index may point to block 156 as the most recently reencrypted block or may point to block 158 as the next block to be reencrypted). Thus, when encryption system 110 reencrypts the next block (e.g., block 158), encryption system 110 may also update indicator 146 (e.g., by incrementing the index).

As may be appreciated, encryption system 110 may use any of a variety of ordering schemes to reencrypt the blocks. In addition to the example given above of reencrypting the blocks in sequentially ascending order, encryption system 110 may reencrypt the blocks in a sequentially descending order, in a ring order (e.g., starting at a block in the middle of the sequence and ascending until reaching the last block, then looping around to continue reencrypting from the first block), or in a more elaborate ordering scheme. For example, encryption system 110 may encrypt every other block in ascending order and then encrypt the remaining blocks in ascending order. In some examples, encryption system 110 may use an ordering formula that specifies an ordering for all of the blocks (and, e.g., that ensures that each block appears in the ordering exactly once). In these examples, encryption system 110 may reencrypt the blocks of storage system 120 in a predetermined order. In some examples, some block addresses of storage system 120 may have no stored data. Nevertheless, encryption system 110 may mark these block addresses as reencrypted as they appear in the ordering.

In some examples, as mentioned earlier, encryption system 110 may track the reencryption of blocks on storage system 120 individually. For example, indicator 146 may be a map maintained by encryption system 110 that records whether each block on storage system 120 has been reencrypted. As will be explained in greater detail below, in some examples this may allow encryption system 110 to opportunistically reencrypt blocks. Additionally or alternatively, encryption system 110 may prioritize reencrypting blocks based on the sensitivity of the underlying data and/or one or more data security policies that apply to the underlying data.

While examples provided herein describe encryption system 110 as performing encryption, decryption, and reencryption operations on an individual block level, encryption system 110 may perform these operations at any suitable level of granularity (e.g., groups of a fixed number of blocks, file-by-file, etc.).

As mentioned earlier, encryption system 110 may reencrypt data on storage system 120 in live conditions (e.g., while storage system 120 is online and available to read and write data). Accordingly, encryption system 110 may reencrypt blocks on storage system 120 while storage system 120 is idle and/or when encryption system 110 determines that performing a reencryption operation would not interfere with a production I/O operation (e.g., by consuming the capacity of storage system 120 to perform I/O operations and/or by consuming the capacity of encryption system 110 to process I/O requests, including encryption and/or decryption operations). Thus, for example, encryption system 110 may have reencrypted blocks 152, 154, and 156 when not processing other I/O requests and may have paused the reencryption process while processing other I/O requests. When encryption system 110 determines that reencrypting a block of data would interfere with a production I/O operation, encryption system 110 may delay reencrypting the block of data until determining that reencrypting the block will not interfere with a production I/O operation.

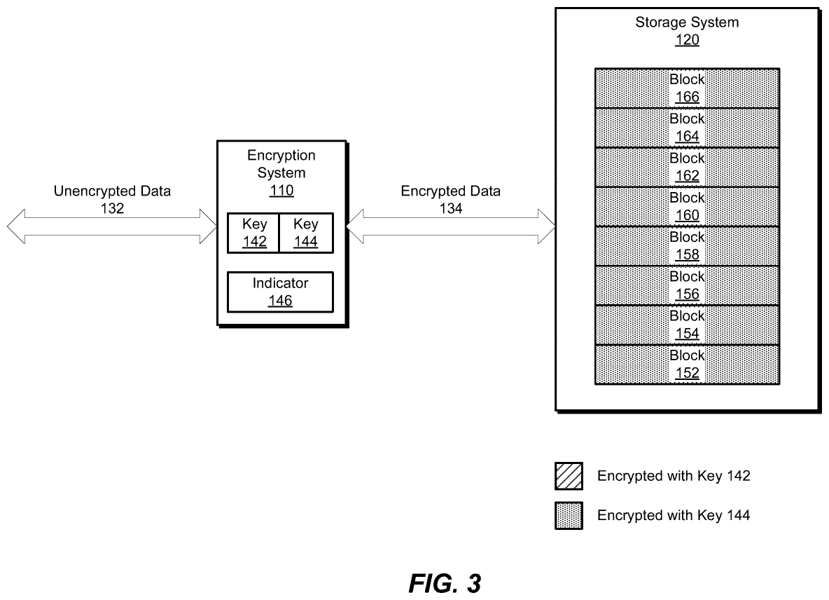

FIG. 3 is an illustration of system 100 of FIGS. 1 and 2 in a state of completed key rotation. As shown in FIG. 3, encryption system 110 may have reencrypted all blocks on storage system 120 with key 144. After reencrypting all blocks previously encrypted with key 142 with key 144, encryption system 110 may have completed the live encryption key rotation. In some examples, encryption system 110 may (either immediately or at a future point in time based on one or more instructions, schedules, and/or policies) initiate a new live encryption key rotation, where key 144 is the old key and an additional key is introduced as the key to replace use of key 144.

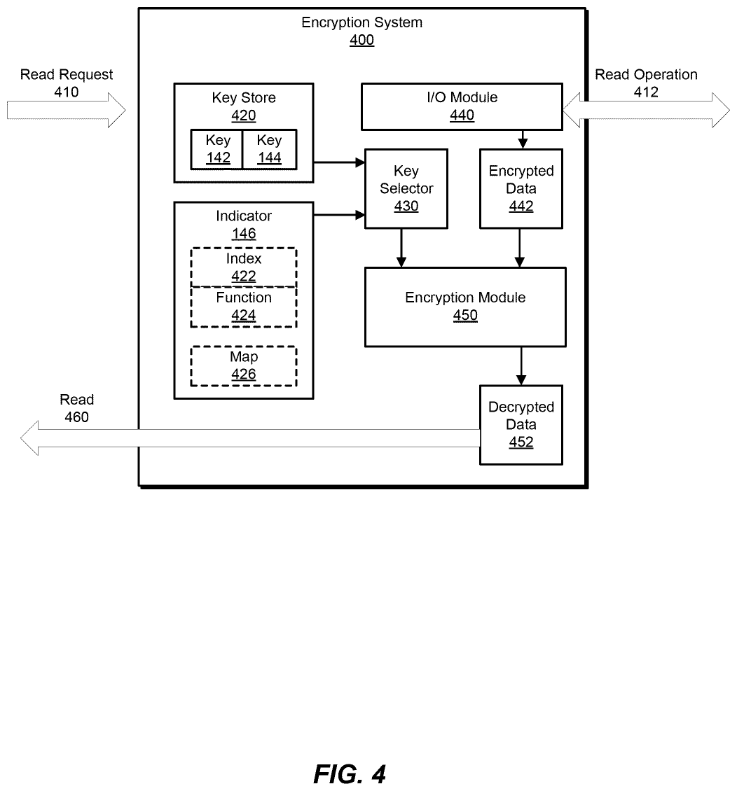

FIG. 4 is an illustration of an encryption system 400 processing a read request 410 in accordance with some embodiments. In some examples, encryption system 400 may implement encryption system 100 of FIGS. 1-3.

As shown in FIG. 4, encryption system 400 may include a key store 420 that stores keys 142 and 144. Encryption system 400 may also maintain and/or store an indicator 146. In some examples, indicator 146 may include an index 422 and a function 424, where function 424 describes an ordering of blocks and index 422 describes a current place within the ordering.

Encryption system 400 may also include a key selector 430 that selects an appropriate key from key store 420 to perform cryptographic operations. For example, when encryption system 400 receives read request 410, key selector 430 may determine, based on indicator 146, with which key within key store 420 the target of read request 410 is encrypted. Key selector 430 may then select that key for use by encryption module 450. Meanwhile, an I/O module 440 may retrieve encrypted data 442 via a read operation 412. Encryption module 450 may then, using the selected key, decrypt encrypted data 442, resulting in decrypted data 452. Encryption system 400 may then fulfill read request 410 with a read 460 that returns decrypted data 452.

As may be appreciated, because encryption system 400 selects a key from key store 420 based on indicator 146 (i.e., an indicator of the progress of the live encryption key rotation), encryption system 400 may successfully facilitate read requests on storage systems even when the reencryption process is still underway and the storage system is encrypted with a mix of keys.

Key selector 430 and encryption module 450 may be implemented in any suitable manner. In some examples, key selector 430 and/or encryption module 450 may be implemented using one or more processing devices, including, e.g., a microprocessor, an Application-Specific Integrated Circuit (ASIC), and/or a Field-Programmable Gate Array (FPGA). In various examples, key store 420 and/or indicator 146 may be stored in memory.

In one example, a device that acts as a data-at-rest encryption device may include the key selector, the encryption module, and the I/O module. For example, the data-at-rest encryption device may implement the encryption key selector, the encryption module, and the I/O module in an FPGA which proxies Internet Small Computer Systems Interface (iSCSI) requests and responses between client computers and a storage controller. In some examples, this FPGA implementation may include an external persistent memory to use as the key store. In some examples, the indicator may be stored on the target storage device itself, either at the beginning or end of the disk, with a minimal impact to capacity available to the user.

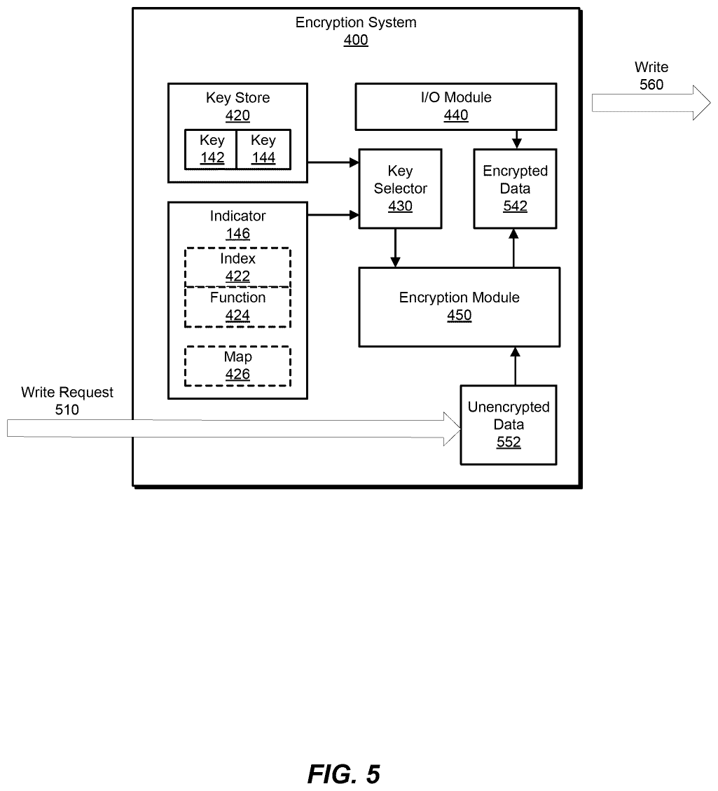

FIG. 5 is an illustration of encryption system 400 processing a write request 510 in accordance with some embodiments. As shown in FIG. 5, write request 510 may include unencrypted data 552 to write to a storage system. Encryption system 400 may handle the write request 510 in any of a number of ways.

In one example, encryption system 400 may facilitate performing write request 510 by selecting a key from key store 420 that reflects the current state of reencryption progress achieved by encryption system 400. For example, the target block of write request 510 may be a block that is currently still encrypted with key 142. Accordingly, key selector 430 may select key 142 for encrypting unencrypted data 552, resulting in encrypted data 542. Alternatively, the target block of write request 510 may be a block that has already been reencrypted with key 144. Accordingly, key selector 430 may select key 144 for encrypting unencrypted data 552. In this manner, the reencryption status of the target block of write request 510 may be left unchanged. This approach may be useful when indicator 146 is based on index 422 and function 424, such that all blocks to one side of index 422 pertain to key 142 and all blocks to the other side of index 422 pertain to key 144.

In another example, encryption system 400 may simply use key 144 to encrypt unencrypted data 552. This approach may be useful when indicator 146 is based on map 426, such that the reencryption blocks on the storage system in an arbitrary order can be recorded in map 426. By opportunistically using the new key 144 to encrypt write data from write requests 510 received during the reencryption process, encryption system 400 may perform the reencryption process more efficiently.

After encryption module 450 produces encrypted data 542, encryption system 400 may perform a write 560 to the storage system.

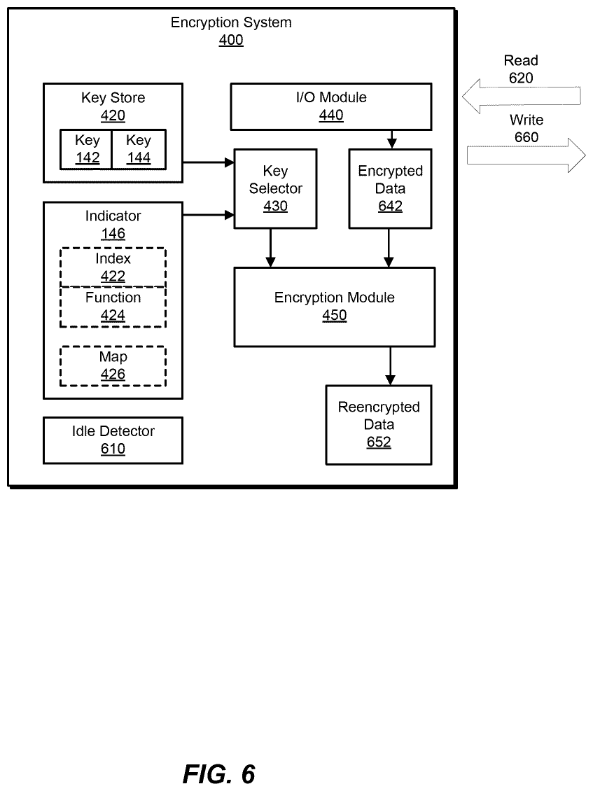

FIG. 6 is an illustration of encryption system 400 performing live key rotation operations in accordance with some embodiments. As shown in FIG. 6, in some examples encryption system 400 may include an idle detector 610. Idle detector 610 may determine when the storage system and/or encryption system 400 has capacity to perform reencryption operations. In some examples, idle detector 610 may determine that the storage system and/or encryption system 400 has capacity to perform reencryption operations by determining that the storage system is not currently performing any operations and/or that encryption system 400 is not currently performing any operations. In some examples, idle detector 610 may determine that the storage system and/or encryption system 400 has capacity to perform reencryption operations by determining that a current level of activity of the storage system and/or encryption system 400 falls below a predetermined threshold. In some examples, idle detector 610 may determine that the storage system and/or encryption system 400 has capacity to perform reencryption operations at least in part by projecting I/O activity. For example, encryption system 400 may determine that a series of blocks are being written or read (e.g., as a part of a file operation), and so may regard the storage system and/or encryption system 400 as not having sufficient capacity to perform reencryption operations until the batch of I/O operations have all been processed. As another example, encryption system 400 may take factors into account such as the time of day and may, e.g., perform reencryption operations more aggressively at times when I/O activity is projected to be lower.

When encryption system 400 determines that there is capacity to perform a reencryption operation, encryption system 400 identifies, based on indicator 146, the next block of the storage system to reencrypt. Encryption system 400 then performs a read 620 of the block, retrieving encrypted data 642. Encryption module 450 then decrypts encrypted data 642 (e.g., with key 142) and reencrypts the data (e.g., with key 144), producing reencrypted data 652. Encryption system 400 then performs a write 660 of reencrypted data 652.

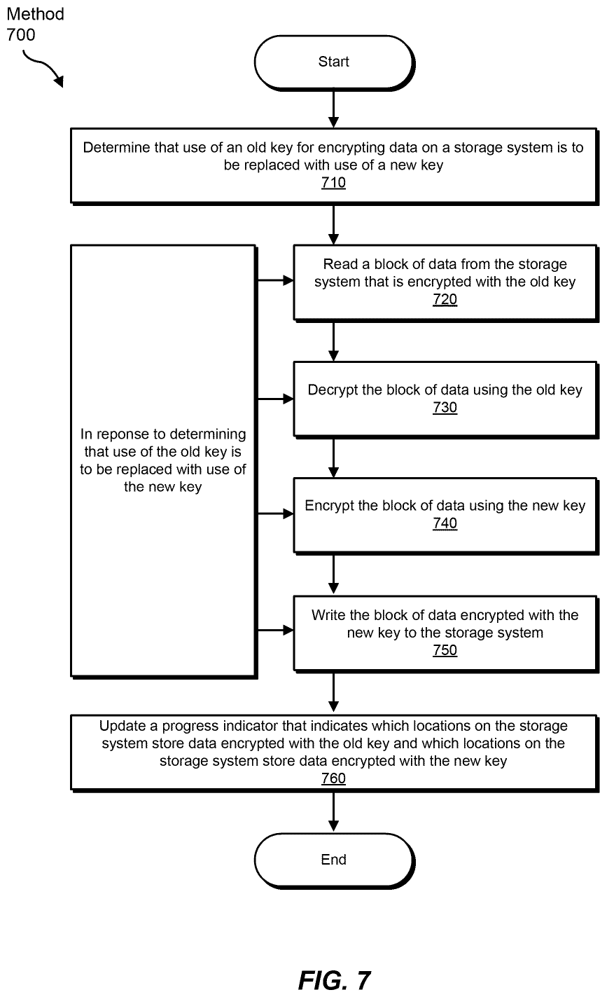

FIG. 7 is a flow diagram of a computer-implemented method 700 for live encryption key rotation in accordance with some embodiments. As shown in FIG. 7, at step 710 method 700 may include determining that use of an old key for encrypting data on a storage system is to be replaced with use of a new key. Systems described herein may perform step 710 in any suitable manner. For example, these systems may determine that the old key has expired according to a data security policy, that the old key has potentially been compromised, and/or that the old key is otherwise potentially insecure.

As shown in FIG. 7, in response to determining that use of the old key is to be replaced with use of the new key, systems described herein may perform steps 720, 730, 740, and 750 of method 700.

At step 720, method 700 may include reading a block of data from the storage system that is encrypted with the old key. At step 730, method 700 may include decrypting the block of data using the old key. At step 740, method 700 may include encrypting the block of data using the new key. At step 750, method 700 may include writing the block of data encrypted with the new key to the storage system.

At step 760, method 700 may include updating a progress indicator that indicates which locations on the storage system store data encrypted with the old key and which locations on the storage system store data encrypted with the new key. In some examples, the progress indicator may include an index that divides the storage system into locations that have not yet been reencrypted and locations that have been reencrypted. In these examples, reading the block of data may include selecting the block of data as next to be reencrypted based on being at a location pointed to by the index. Updating the progress indicator may then include incrementing the index.

In some examples, the progress indicator may include a map of the storage system that records which locations on the storage system have been reencrypted and which locations on the storage system have not been reencrypted. In these examples, updating the progress indicator may include marking the map to show that the location of the data block has been reencrypted.

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Examples of processing devices include a traditional microprocessor (such as Intel's x86 and x64 architectures), but also matrix processors, graphics processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

In one example, any number of systems or circuits illustrated in the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the figures and/or description may be implemented as stand-alone modules (e.g., a device with associated components and circuitry configured to perform a specific application or function) or implemented as plug-in modules into application specific hardware of electronic devices.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
determining that use of an old key for encrypting data on a storage system is to be replaced with use of a new key;
in response to determining that use of the old key is to be replaced with use of the new key:
reading a block of data from the storage system that is encrypted with the old key;
decrypting the block of data using the old key;
encrypting the block of data using the new key; and
writing the block of data encrypted with the new key to the storage system; and
updating a progress indicator that indicates which locations on the storage system store data encrypted with the old key and which locations on the storage system store data encrypted with the new key.

2. The method of claim 1, wherein the storage system is configured to perform production input/output operations after replacing use of the old key with use of the new key has started but before replacing use of the old key with use of the new key has completed.

3. The method of claim 1, wherein reading the block of data from the storage system that is encrypted with the old key is further in response to determining that the progress indicator indicates that the block of data has not yet been reencrypted with the new key.

4. The method of claim 1, further comprising:
receiving, while reencryption of the storage system with the new key in place of the old key is in progress, a production write operation to store a write block to a target location of the storage system;
selecting between the old key and the new key based on the progress indicator; and
encrypting the write block using the selected key.

5. The method of claim 1, further comprising:
receiving, while reencryption of the storage system with the new key in place of the old key is in progress, a production write operation to store a write block to a target location of the storage system that is currently encrypted using the old key;
encrypting the write block using the new key; and
updating the progress indicator to reflect that the target location is encrypted using the new key.

6. The method of claim 1, further comprising:
receiving, while reencryption of the storage system with the new key in place of the old key is in progress, a production read operation to retrieve a read block from a target location of the storage system;
selecting between the old key and the new key based on the progress indicator; and
decrypting the read block using the selected key.

7. The method of claim 1, wherein reading the block of data from the storage system that is encrypted with the old key is further in response to determining that reencrypting the block of data will not interfere with a production input/output operation by the storage system.

8. The method of claim 7, further comprising:
determining that reencrypting the block of data will interfere with at least one production input/output operation by the storage system; and
delaying reencryption of the block of data until determining that reencrypting the block of data will not interfere with a production input/output operation by the storage system.

9. The method of claim 1, wherein:
the progress indicator comprises an index that divides the storage system into locations that have not yet been reencrypted and locations that have been reencrypted;
reading the block of data comprises selecting the block of data as next to be reencrypted based on being at a location pointed to by the index; and
updating the progress indicator comprises incrementing the index.

10. The method of claim 1, wherein:
the progress indicator comprises a map of the storage system that records which locations on the storage system have been reencrypted and which locations on the storage system have not been reencrypted; and
updating the progress indicator comprises marking the map to show that the location of the data block has been reencrypted.

11. A device comprising:
at least one processor; and
at least one memory containing instructions that, when executed by the processor, cause the processor to:
determine that use of an old key for encrypting data on a storage system is to be replaced with use of a new key;
in response to determining that use of the old key is to be replaced with use of the new key:
read a block of data from the storage system that is encrypted with the old key;
decrypt the block of data using the old key;
encrypt the block of data using the new key; and
write the block of data encrypted with the new key to the storage system; and
update a progress indicator that indicates which locations on the storage system store data encrypted with the old key and which locations on the storage system store data encrypted with the new key.

12. The device of claim 11, wherein the storage system is configured to perform production input/output operations after replacing use of the old key with use of the new key has started but before replacing use of the old key with use of the new key has completed.

13. The device of claim 11, wherein reading the block of data from the storage system that is encrypted with the old key is further in response to determining that the progress indicator indicates that the block of data has not yet been reencrypted with the new key.

14. The device of claim 11, the instructions further causing the processor to:
receive, while reencryption of the storage system with the new key in place of the old key is in progress, a production write operation to store a write block to a target location of the storage system;
select between the old key and the new key based on the progress indicator; and
encrypt the write block using the selected key.

15. The device of claim 11, the instructions further causing the processor to:
receive, while reencryption of the storage system with the new key in place of the old key is in progress, a production write operation to store a write block to a target location of the storage system that is currently encrypted using the old key;
encrypt the write block using the new key; and
update the progress indicator to reflect that the target location is encrypted using the new key.

16. The device of claim 11, the instructions further causing the processor to:
receive, while reencryption of the storage system with the new key in place of the old key is in progress, a production read operation to retrieve a read block from a target location of the storage system;
select between the old key and the new key based on the progress indicator; and
decrypt the read block using the selected key.

17. The device of claim 11, wherein reading the block of data from the storage system that is encrypted with the old key is further in response to determining that reencrypting the block of data will not interfere with a production input/output operation by the storage system.

18. The device of claim 17, wherein the instructions further cause the processor to:
determine that reencrypting the block of data will interfere with at least one production input/output operation by the storage system; and
delay reencryption of the block of data until determining that reencrypting the block of data will not interfere with a production input/output operation by the storage system.

19. A system comprising:
a storage device;
at least one processor; and
at least one memory containing instructions that, when executed by the processor, cause the processor to:
determine that use of an old key for encrypting data on the storage device is to be replaced with use of a new key;
in response to determining that use of the old key is to be replaced with use of the new key:
read a block of data from the storage device that is encrypted with the old key;
decrypt the block of data using the old key;
encrypt the block of data using the new key; and
write the block of data encrypted with the new key to the storage device; and
update a progress indicator that indicates which locations on the storage device store data encrypted with the old key and which locations on the storage device store data encrypted with the new key.

20. The system of claim 19, wherein the storage device is configured to perform production input/output operations after replacing use of the old key with use of the new key has started but before replacing use of the old key with use of the new key has completed.
